(19) United States
(12) Patent Application Publication
(10) Pub. No.: US 2017/0264169 A1
(43) Pub. Date: Sep. 14, 2017

(54) ELECTRODYNAMIC MACHINE COMPRISING A COOLING DUCT

(71) Applicant: Siemens Aktiengesellschaft, Munich (DE)

(72) Inventors: Carina Kowalski, Mülheim an der Ruhr (DE); Matthias Kowalski, Mülheim an der Ruhr (DE)

(73) Assignee: Siemens Aktiengesellschaft, Munich (DE)

(21) Appl. No.: 15/509,615

(22) PCT Filed: Sep. 10, 2015
(86) PCT No.: PCT/EP2015/070703

§ 371 Date: Mar. 8, 2017

(30) Foreign Application Priority Data
Sep. 18, 2014 (EP) 14185256.6

(51) Int. Cl. H02K 9/08

(52) U.S. Cl. CPC H02K 9/08

(57) ABSTRACT

A turbine generator of the reverse-flow type having a rotor winding and a stator winding and a cooling duct, wherein the cooling duct is designed as a diffuser. The diffuser is designed such that a device is arranged on an internal cooling duct wall, which device prevents the flow of the cooling medium from stalling, leading to an improved, more uniform flow to a cooling apparatus.

### CROSS REFERENCE TO RELATED APPLICATIONS

This application is the US National Stage of International Application No. PCT/EP2015/070703 filed Sep. 10, 2015, and claims the benefit thereof. The International Application claims the benefit of European Application No. EP14185256 filed Sep. 18, 2014. All of the applications are incorporated by reference herein in their entirety.

### FIELD OF INVENTION

The invention relates to an electrodynamic machine having a rotor winding and a stator winding and a cooling duct which is designed for the passage of a coolant and is limited by duct walls.

### BACKGROUND OF INVENTION

Electrodynamic machines such as, for example, turbine generators generally comprise a rotatably mounted rotor which comprises a rotor winding, and a stator, arranged around the rotor, which comprises a stator winding. During operation, a relatively high electrical current flows through both the rotor winding and the stator winding. The rotor winding is formed such that a magnetic field occurs, wherein a voltage is induced in the stator winding by the rotating movement of the rotor. The electrical energy which thus occurs is then fed to electrical consumers by suitable supply and transmission grids.

In modern turbine generators, the currents in the rotor and/or stator winding are so high that a risk of overheating occurs. Turbine generators therefore need to be cooled. This can be effected by flowing air, gas such as, for example, hydrogen, or water through them.

So-called reverse-flow turbine generators are known, which comprise a fan, which suck the warm gas from the inside of the turbine generator and push it into a cooler from where it flows through the inside of the turbine generator again.

A diffuser is arranged between the fan and the cooler which is designed to widen the flow with low losses in order to enable a more uniform flow onto the cooler.

However, in modern turbine generators the radius of curvature of the diffuser is not optimally designed because of the limited space for installation. The radius of curvature is instead chosen to be too small with the result that flow separation ensues. An undesired increased mechanical load on the cooler is thus obtained, which results in suboptimal use.

### SUMMARY OF INVENTION

An object of the invention is to modify the diffuser such that optimal flow onto a cooler is possible.

This object is achieved by an electrodynamic machine comprising a rotor winding and a stator winding and a cooling duct which is designed for the passage of a coolant and is limited by duct walls, wherein the duct walls have means for increasing turbulence in the flow of the coolant. The turbulent kinetic energy in the boundary layer region is increased at the duct wall by the invention.

It is thus proposed according to the invention to arrange means on the duct surface in order to generate turbulence. This turbulence slows down separation of the flow. The flow thus follows the profile of the duct walls. As a result, the flow onto a cooler, arranged at the end of the diffuser, is optimal.

Advantageous developments are provided in the dependent claims.

The cooling duct is designed as a diffuser. A diffuser is a component which slows down the flows of gas or fluid and increases the pressure of the gas or fluid. A diffuser is thus in principle the opposite of a nozzle. With a diffuser, kinetic energy is recycled into pressure energy. This is achieved by a continuous or discontinuous widening of the flow cross-section. According to the invention, a means for increasing turbulence in the flow is arranged on the duct wall of the diffuser.

A cooler is arranged on a diffuser end on a diffuser which has said diffuser end. The loss of flow is as small as possible owing to the direct or indirect arrangement of a cooler on the diffuser. The cooling action of the cooler can thus be exploited optimally.

In a further advantageous embodiment, the diffuser has an inner cooling duct wall with a first radius of curvature and an outer cooling duct wall with a second radius of curvature, wherein the first radius of curvature is smaller than the second radius of curvature, wherein the means is arranged on the inner cooling duct wall. This inner cooling duct wall can, for example, be the inside of the diffuser outer wall.

The rotor of the electrodynamic machine is designed so that it can rotate about an axis of rotation. The stator is likewise designed so that it is essentially rotationally symmetrical about the axis of rotation. The coolant situated in the electrodynamic machine is guided by the fan initially essentially axially, i.e. parallel to the axis of rotation. The fan that is responsible for this movement of the flow medium is generally arranged at the front, wherein the cooler, which is designed to cool the coolant, is arranged for space reasons at no more than 90 degrees to the direction of flow of the flow medium, at the front of the electrodynamic machine. The diffuser thus must, on the one hand, deflect the flow and, on the other hand, decelerate it and convert the kinetic energy into pressure energy. Viewed in the initially axial direction of flow, the diffuser thus has an outer cooling duct wall which is arranged closer to the axis of rotation than the inner cooling duct wall. From a flow perspective, the radius of the inner cooling duct wall, such as for example the inside of the diffuser outer wall, is smaller than the radius of the outer cooling duct wall, such as for example the inside of the diffuser outer wall. The cooling flow is thus separated at the inner cooling duct wall. Flow separation can be prevented by attaching a means upstream from the expected detachment of the flow if the means is designed to increase turbulence in the flow of the coolant.

In an advantageous development, the means is designed as a trip wire. The trip wire is essentially a raised portion on the inner cooling duct wall which represents flow resistance for the flow of the coolant. The trip wire is hereby arranged in such a way that the flow medium which flows with a direction of flow which is essentially parallel to the axis of rotation also strikes the trip wire more or less simultaneously. This means that the trip wire is oriented at essentially 90 degrees to the direction of flow. If the diffuser is designed so that it is rotationally symmetrical with respect to the axis of rotation, viewed in the direction of the axis of rotation the trip wire is a ring which is arranged on the inner cooling duct wall. This ring stands perpendicular to the axis of rotation and causes the coolant to flow onto the trip wire with the same speed component.

In an advantageous development, if the means is designed as a depression, similar to the surface of a golf ball, both the inner cooling duct wall and the outer cooling duct wall can also be provided with a surface which is like that of a golf ball. This means that multiple depressions are arranged on the surface of the inner cooling duct wall, such as for example the inside of the diffuser outer wall, and/or of the outer cooling duct wall, such as for example that side of the diffuser inner wall which faces the flow. These depressions are approximately circular recesses in the material. Other geometries are, however, also conceivable; the depression can thus, for example, be a depression which is angular in form. The depression can be a rectangular recess in the material. This rectangular recess in the material can be made, for example, by a stamp which can be produced easily in the diffuser wall.

In a further advantageous development, both the inner cooling duct wall and the outer cooling duct wall can be designed with multiple raised portions. A surface with such a design would then essentially be similar to the skin of a shark. The sharkskin design has ridglets, which can also be referred to as small ridges. Such a surface geometry results in a reduction of the frictional resistance on surfaces over which there is a turbulent flow. These surface geometries are thin ridges which have a very sharp ridge tip. These ridges are arranged parallel to the direction of flow, wherein the dimensions of these thin ribs arranged parallel to the direction of flow are dependent on the speed and the viscosity of the coolant. These ribs or ridges can be designed using materials technology or from the same material as the inner cooling duct wall. In an alternative embodiment, a ribbed film can be used.

In a further advantageous development, the cooler and the diffuser are arranged at the front of the electrodynamic machine.

The abovedescribed properties, features, and advantages of this invention, as well as the manner in which these are achieved, will become clearer and more easily understandable in conjunction with the following description of the exemplary embodiments which are explained in detail in conjunction with the drawings.

Exemplary embodiments of the invention are described below with the aid of the drawings. These are intended not to show the exemplary embodiments to scale, and instead the drawings are probably of use for explanatory purposes and take a schematic and/or slightly distorted form. Reference should be made to the relevant prior art with respect to the supplementary teaching which can be seen directly in the drawings.

### BRIEF DESCRIPTION OF THE DRAWINGS

Identical components or components with the same function are here designated with the same reference numerals.

In the drawings,

FIG. 1 shows a schematic view in cross-section of a turbine generator;

FIG. 2 shows a schematic view in cross-section of part of the diffuser;

FIG. 3 shows a schematic view in cross-section of part of the diffuser in an embodiment according to the invention.

### DETAILED DESCRIPTION OF INVENTION

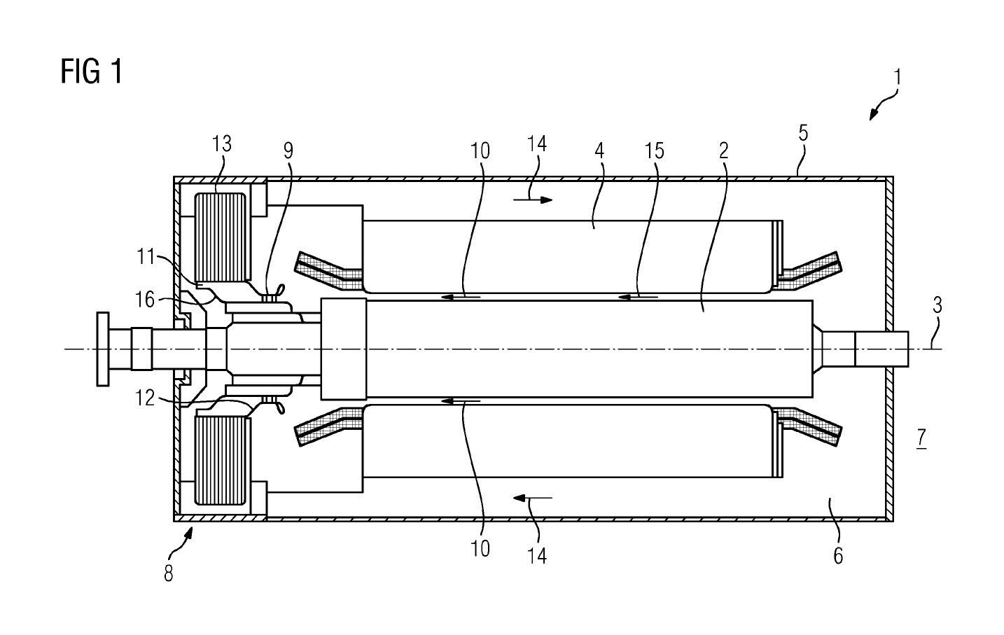

As a result of the embodiment according to the invention, with the means for increasing turbulence, the mechanical load on the cooler is reduced and also entails better exploitability of the cooler. FIG. 1 shows a turbine generator 1 as an embodiment of an electrodynamic machine. The turbine generator 1 essentially comprises a rotor 2 with a rotor winding (not shown in detail). The rotor 2 is mounted so that it can rotate about an axis of rotation 3. A stator 4 with a stator winding (not shown in detail) is arranged around the rotor 2. Lastly, a turbine generator housing 5, which seals off the turbine generator inner housing 6 from the external environment 7, is arranged around the stator 4. A coolant, such as for example air or a gas such as hydrogen, situated in the inside 6 of the turbine generator is thus unable to pass to the outside 7. During operation, a relatively high current flows through both the rotor winding and the stator winding. Both the rotor winding and the stator winding thus need to be cooled appropriately. This is effected by the rotor 2 or cooling bores arranged in the stator 4 and through which a suitable coolant flows. Air, gas such as hydrogen, or water are known as coolants.

The rotor 2 rotates with a frequency of, for example, 50 Hz. Other frequencies are also known.

A fan 9, which sucks coolant situated in the inside 6 of the turbine generator, is arranged at the front 8. This is shown by the arrows 10 which point toward the fan 9, from the right to the left within the plane of the drawing. For reasons of clarity, only two arrows have been labeled with the reference numeral 10. The design of the turbine generator 1 is a so-called reverse-flow type. This means that the direction of flow of the coolant is from the inside to the outside. This means that the coolant is moved to the front of the turbine generator 1 via the fan 9. Other structures are known in which the coolant is moved to the front in the inside 6 of the turbine generator via a fan or a ventilator.

The turbine generator 1 has a cooling duct 11 which is designed for the passage of coolant and is limited by duct walls 12. The coolant first flows parallel to the axis of rotation 3 toward the fan 9 and is then diverted in the cooling duct 11 to a cooler 13. The heated coolant is cooled again in the cooler 13 and flows into the inside 6 of the turbine generator under the action of the fan, as shown by the flow arrows 14 in FIG. 1. For space reasons, the cooler 13 is arranged at essentially 90 degrees to the main direction of flow 15 of the coolant, wherein the main direction of flow 15 is oriented essentially parallel to the axis of rotation 3. The duct wall 12 has means 26 for increasing turbulence in the flow of the coolant. The cooling duct 11 is essentially designed as a diffuser 16.

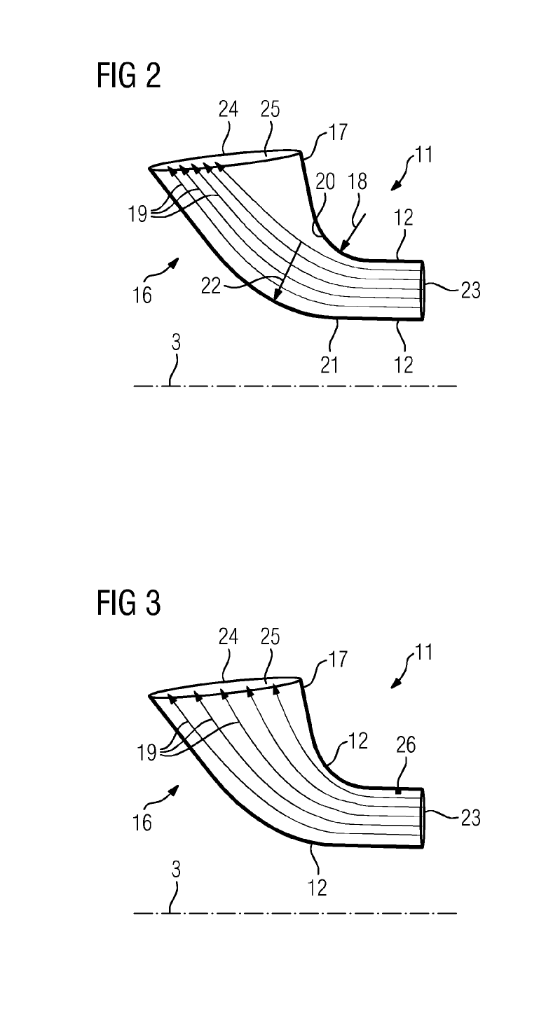

FIGS. 2 and 3 show a portion of the diffuser 16, wherein FIG. 2 shows the diffuser 16 without the means 26 according to the invention, and FIG. 3 with the means according to the invention. The diffuser 16 is designed like a trumpet and is rotationally symmetrical about the axis of rotation 3 and has an inner cooling duct wall 17. This inner cooling duct wall 17 is characterized by a first radius of curvature 18. This means that the flow which is shown in FIGS. 2 and 3 by lines of flow 19 describes a curve which, viewed in the direction of flow, describes a curve to the right. Flow separation can occur at a separation point 20 as a result of a first radius of curvature 18 that is too small. The diffuser 16 moreover has an outer cooling duct wall 21 which is characterized by a second radius of curvature 22. As can be clearly seen in FIG. 2, the diffuser is characterized in that the first radius of curvature 18 is smaller than the second radius of curvature 22. The diffuser has a first flow cross-section 23 which is arranged at the inlet to the diffuser 16. The second flow cross-section 24 is at the outlet 25 of the diffuser 16, wherein the second flow cross-section 24 is greater than the first flow cross-section 23, as must be the case for a diffuser 16. The cooler 13 is arranged directly at the outlet 25 of the diffuser 16. As can be seen in FIG. 2, the flow at the outlet 25 of the diffuser 16 is concentrated on the outer cooling duct wall 21. According to the invention, this needs to be prevented, as shown in FIG. 3. For the sake of clarity, the reference numerals of the geometric features of the diffuser 16 have not been repeated in FIG. 3. The diffuser 16 in FIG. 3 is identical to that in FIG. 2 in its external geometrical features. The difference from FIG. 2 is that the inner cooling duct wall 17 has a means 26 for increasing turbulence in the flow of the coolant. In the example selected in FIG. 3, the means 26 takes the form of a trip wire. This means that the means 26 displays a slightly raised portion relative to the first cooling duct wall 17, which entails an influence on the flow of the coolant. The lines of flow 19, which owing to the introduction of the means 26 have a different characteristic than in FIG. 2, are shown in FIG. 3. It can be clearly seen that the lines of flow 19 at the outlet 25 display a more uniform orientation. This means that the flow onto the cooler 13, which is arranged at the outlet 25, is more uniform. As a result, a mechanical load on the cooler 13 is reduced. This results in better exploitation of the cooler 13. The trip wire is arranged around the whole cooling duct wall 17 such that essentially a ring, which cannot be shown in FIG. 3, is formed. The ring is arranged so that it is rotationally symmetrical about the axis of rotation 3.

In alternative embodiments, depressions can be arranged at the location of the means 26 designed as a trip wire. This is not shown in FIG. 3. These depressions can be designed like the surface of a golf ball. This means that the depressions are arranged regularly spaced apart on the inner cooling duct wall 17. The size and distribution of the depressions can be adapted accordingly to the flow conditions. In each case, the means 26 causes turbulence at the inner cooling duct wall 17.

In a further alternative embodiment, the means 26 can be designed with multiple raised portions. This means that a so-called sharkskin is formed at the location of the means 26. Such a sharkskin is characterized by pointed ridges, wherein the ridges are arranged longitudinally in the direction of flow. A detailed description of the sharkskin is not given here. The sharkskin is characterized by multiple ridges arranged parallel to one another.

Although the invention has not been illustrated and described in detail by the preferred exemplary embodiment, the invention is not limited by the examples disclosed and other variants can be derived by a person skilled in the art without going beyond the scope of the invention.

1. An electrodynamic machine comprising
a rotor winding and a stator winding and a cooling duct which is designed for the passage of a coolant and is limited by duct walls,
wherein the duct walls have means for increasing turbulence in the flow of the coolant, wherein the cooling duct is designed as a diffuser, wherein the diffuser has a diffuser end and a cooler is arranged at the diffuser end,
wherein the means for increasing turbulence are arranged on the surface of the duct wall in such a way that the turbulence slows down separation of the flow such that the flow onto the cooler arranged at the end of the diffuser is optimal.

2. The electrodynamic machine as claimed in claim 1,
wherein the diffuser has an inner cooling duct wall with a first radius of curvature and an outer cooling duct wall with a second radius of curvature, wherein the first radius of curvature is smaller than the second radius of curvature, wherein the means for increasing turbulence is arranged on the inner cooling duct wall.

3. The electrodynamic machine as claimed in claim 1,
wherein the means for increasing turbulence is designed as a trip wire.

4. The electrodynamic machine as claimed in claim 1,
wherein the means for increasing turbulence is a depression.

5. The electrodynamic machine as claimed in claim 1,
wherein the means for increasing turbulence has multiple raised portions.

6. The electrodynamic machine as claimed in claim 1,
wherein the cooler and the diffuser are arranged at the front.
